(19) United States
(12) Patent Application Publication
(10) Pub. No.: US 2017/0083086 A1
(43) Pub. Date: Mar. 23, 2017

(54) Human-Computer Interface

(71) Applicants: Kai Mazur, United, CA (US); Tony Chu, Santa Rosa, CA (US)

(72) Inventors: Kai Mazur, United, CA (US); Tony Chu, Santa Rosa, CA (US)

(21) Appl. No.: 15/266,341

(22) Filed: Sep. 15, 2016

Related U.S. Application Data
(60) Provisional application No. 62/220,300, filed on Sep. 18, 2015.

(51) Int. Cl. G06F 3/01; G06F 3/03; A63F 13/655; G06F 3/0481; G06F 3/0484; A63F 13/67; G06K 9/00; G06F 3/0485

(52) U.S. Cl. CPC G06F 3/012; G06K 9/00315; G06F 3/0304; G06F 3/0485; G06F 3/04812; G06F 3/04845; A63F 13/67; A63F 13/655; G06F 2203/04806; A63F 2300/8082; A63F 2300/1093

(57) ABSTRACT

Methods, systems, and apparatus, including computer programs encoded on computer storage media, for a human computer interface. One of the methods includes receiving, from a capture sensor, information indicative of the state of the face of the user. The method includes determining that the user is performing one of a predetermined set of facial movements based on the information. The method includes determining an input command based the determined facial movement. The method also includes providing the input command to a computing device.

### CLAIM OF PRIORITY

This application claims priority under 35 USC §119(e) to U.S. Patent Application Ser. No. 62/220,300, entitled “HUMAN-COMPUTER INTERFACE”, filed on Sep. 18, 2015, the entire contents of which are hereby incorporated by reference.

### BACKGROUND

The current standard methods for human interaction with computer and electronic devices (“human-computer interface”) primarily and almost exclusively involve the hands.

A repetitive strain injury (RSI) is an “injury to the musculoskeletal and nervous systems that may be caused by repetitive tasks, forceful exertions, vibrations, mechanical compression, or sustained or awkward positions. RSIs are also known as cumulative trauma disorders, repetitive stress injuries, repetitive motion injuries or disorders.

Using a computer mouse, track pad, or touch screen requires a person to make small, exact, repetitive movements with his hand, fingers, and thumb. By positioning, travelling, scrolling, and clicking the mouse again and again, the soft tissues can become tired and overworked. This can cause pain (ache, soreness) on the top of the hand; pain (ache, soreness) around the wrist; pain (ache, soreness) along the forearm and entire upper extremity. Repetitive motion or cumulative trauma disorders including tendinitis and tendinosis, carpal tunnel and cubital tunnel syndrome, trigger fingers and other disorders related to soft tissue degeneration are common in the computer related work environment. Additionally, traumatic injuries, neurologic disorders, and birth disorders may limit function of the upper extremity and as such control of an electronic device may be impaired, with formation of painful nodules, and in the later stages, ganglion cysts, around the joints and along the tendons; and numbness and tingling in the thumb and index finger. If severe, using the fingers to tap, pinch, scroll etc. on a touch-screen device, in addition to other activities of daily living in the normal course of a day, may increase pain and decrease usefulness for the user.

### SUMMARY

This specification describes technologies relating to human-computer interfaces.

In general, one innovative aspect of the subject matter described in this specification can be embodied in methods that include the act of receiving, from a capture sensor, information indicative of a state or position of landmarks of the face of the user. The methods include the act of determining that the user is performing one of a predetermined set of facial movements based on the information. The methods include the act of determining an input command based the determined facial movement. The methods also include the act of executing the input command to a computing device.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

Particular embodiments of the subject matter described in this specification can be implemented so as to realize one or more of the following advantages. Instances of repetitive stress injuries in computer device users may be reduced. The experience of users who choose not, cannot or should not use a mouse can be improved.

The foregoing and other embodiments can each optionally include one or more of the following features, alone or in combination. The methods may include the act of comprising locating a cursor on a user interface of the computing device based on a position of a chin or a nose of the user. The position of the chin or the nose may be determined relative to another facial feature of the user. The methods may include the acts of causing a cursor to move based on the movement of the chin or nose of the user. The movement may be determined relative to other facial landmarks or as part of the face as a whole. The facial movement may include at least one of inflating a cheek of the user, sticking out of a tongue of the user, pursing lips of the user, and expanding corners of the lips. Inflating the cheek of the user may cause the computing device to execute to a mouse click input command. Determining the input command may include selecting between a click input command and a double click input command based on a timing and a repetition of the inflating of the cheek. Determining the input command may include selecting between a left click input command and a right click input command based on which check the user inflates. Sticking out of a tongue of the user may cause the computing device to execute to a scroll input command. The direction of the scroll command may be based on the direction of the tongue. Pursing the lips may cause the computing device to execute to a zoom in command. Stretching the lips may cause the computing device to execute to a zoom out command. The methods may include the act of detecting a facial expression indicative of at least one or calm, joy, surprise, fear, anger, disgust, trust, shame, contempt, anticipation, and sadness. The methods may include the act of adjusting the difficulty of a game based on the facial expression. The computing device may be one of a smart phone or tablet. The computing device may include a virtual reality headset. The computing device may enable the user to configure which input commands correspond to which facial movements. The capture sensor may be a camera.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of a human-computer interface based on the facial movement of the user.

FIGS. 2A-C illustrates an example of controlling a computing device using the position of the chin or nose.

FIG. 3A-C illustrates the user controlling a computing device by inflating his checks.

FIGS. 4A-E illustrate an example of the user controlling a computing device using the tongue.

FIGS. 5A-B illustrates an example of a user controlling a computing device using the movement of his mouth.

FIGS. 6A-B illustrate examples of facial expressions that can be detected on the face of the user.

FIG. 7 illustrates an example of different areas of the user's face that can be monitored.

FIG. 8 illustrates a larger view of an example of a workstation operating in lower facial mode.

FIGS. 9A-B illustrate example computing devices which can provide a facial movement translation.

FIG. 10 illustrates an example kiosk that monitors a user's face.

FIGS. 11A-B illustrate handheld devices that utilize facial monitoring.

FIGS. 12A-B illustrates virtual reality headsets that include facial monitoring.

FIG. 13 illustrates an example of using a camera with emotion detection capabilities in a retail establishment.

FIG. 14 illustrates of an example of using a camera in a cockpit.

FIG. 15 is a flowchart of an example of a process for a human computer interface.

Like reference numbers and designations in the various drawings indicate like elements.

### DETAILED DESCRIPTION

A system can track a user's facial movements to 1) control a computer or device, and 2) communicate with other users via the device. Control and manipulation of a computer or electronic computing device requires interaction between the operator and device. This interaction is traditionally accomplished with the user's hand(s) manipulating a mouse or directly manipulating the electronic device. Due to the repetitive nature of these interactions the user's hand(s) or upper extremities may develop cumulative traumatic disorders. Additionally, such interaction precludes the use of the user's hands for other productive activities.

Due to the exquisite control one has over the muscles of the face, for example moving the mouth and jaws (which are physiologically adapted for repetitive but highly controlled tasks like eating and a multitude of facial expressions), facial movement can be used to perform fine precise interactions that may match or exceed that of control by the hands. Moreover, the sum total of facial muscular motion for expression of basic human emotions may be captured, reflected and utilized, for enhancing non-verbal communication between users. There are no other physiologic systems capable of, or adapted for, such high levels of non-verbal human communication.

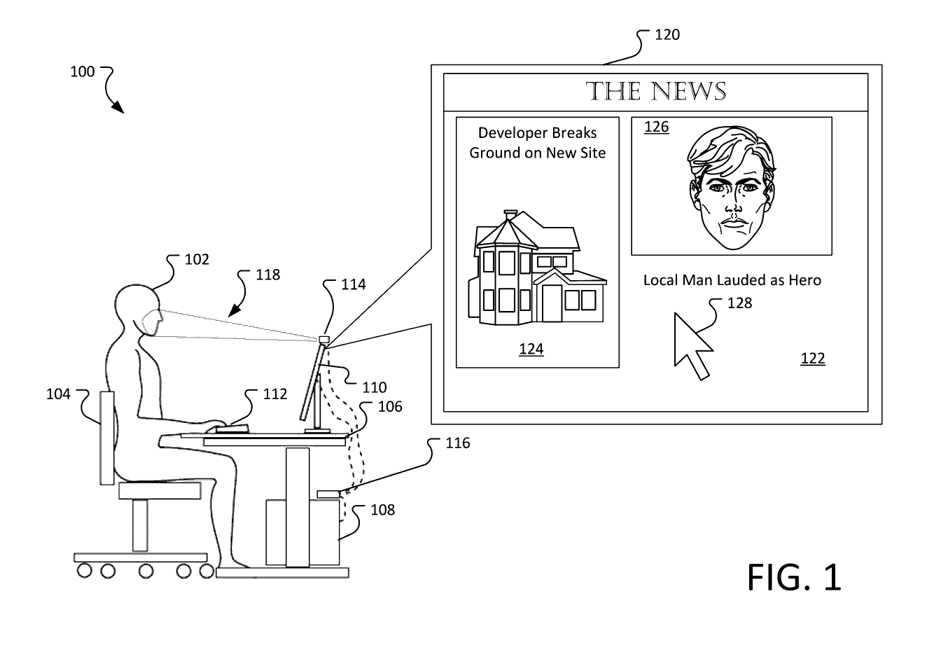

FIG. 1 illustrates an example of a system 100 including a human-computer interface based on the facial movement of a user 102. The user 102 sits in a chair 104 at a desk 106. The user 102 operates a computing device 108. The computing device 108 displays information to the user 102 using a monitor 110 that displays the user interface 120 to the user 102. A keyboard 112 and a capture sensor 114 provide input to the computing device 108. The capture sensor can be, for example, a camera, radar sensor, infra-red camera, or other sensor capable of detecting movement of the user's face. In this example, the capture sensor is connected to a system interface module 116. The system interface module 116 may be a device external to the computing device 108 that receives signals from the capture sensor 114 and provides input signals to the computing device 108. In some implementations, the system interface module 116 may be an in-built part of the computing device. The functionality can be implemented by software executing on the computing device 108.

The user 102 controls the computing device 108 with a combination of a keyboard 112 and facial movement. In this example, the facial movement is captured by the capture sensor 114 and transmitted by the systems interface module 116, translated into computer commands and then sent to the computing device 108.

For example, the user interface 120 includes a display of a web page 122. The web page 122 includes two news stories. A story about a developer 124 and a story about the heroic actions of an individual 126. The user interface 120 also displays a cursor indicator 128. The user 202 can control the cursor indicator 128 and effect the display on the user interface 120. In this example, the capture sensor 114 captures information about the lower portion of the user's face, represented by the cone 118. In some implementations, the system can monitor the lower part of the user's face. In some implementations, the system can monitor the user's entire face.

The system may monitor the way the user 202 moves elements of his face, for example, the chin position of the user 202, the nose position of the user 202, the cheeks of the user 202, the tongue of the user 202, the lips of the user 202, and/or the expression of the user 202.

Using information gathered from the facial movements of the user 102, the computing device 108 causes the user interface 120 to move the cursor indicator 128, select an item, zoom into an item, or perform other actions as explained further below.

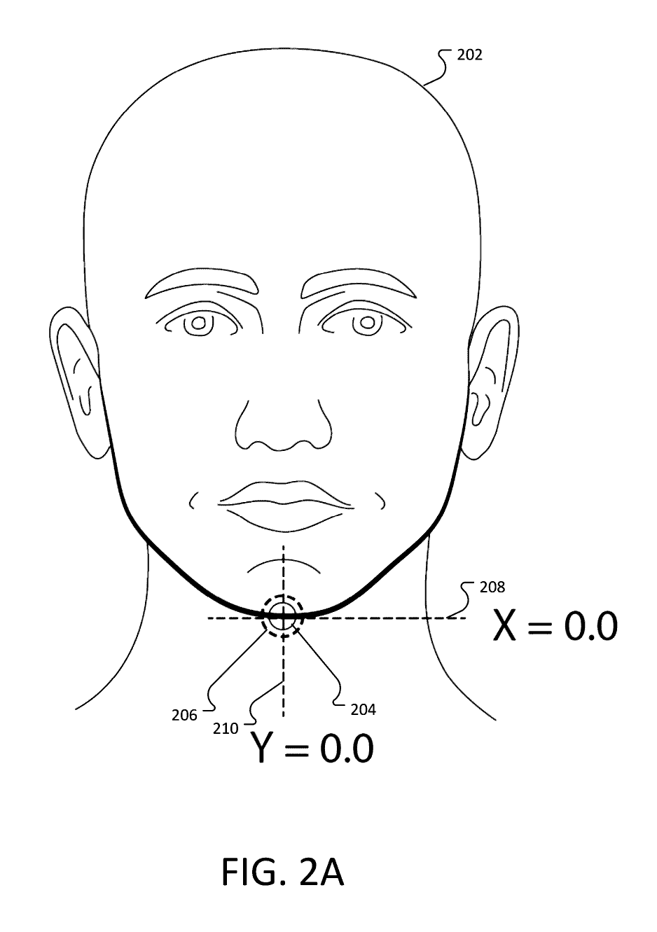

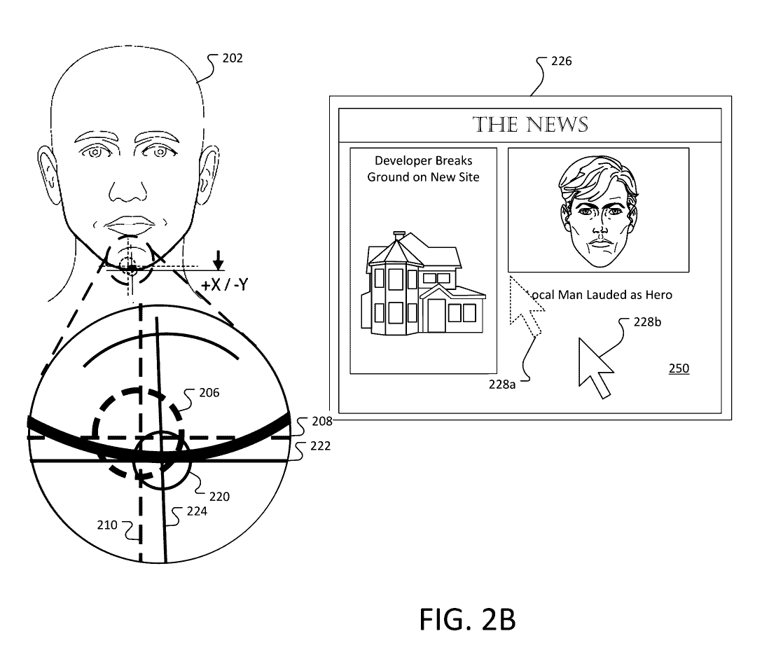

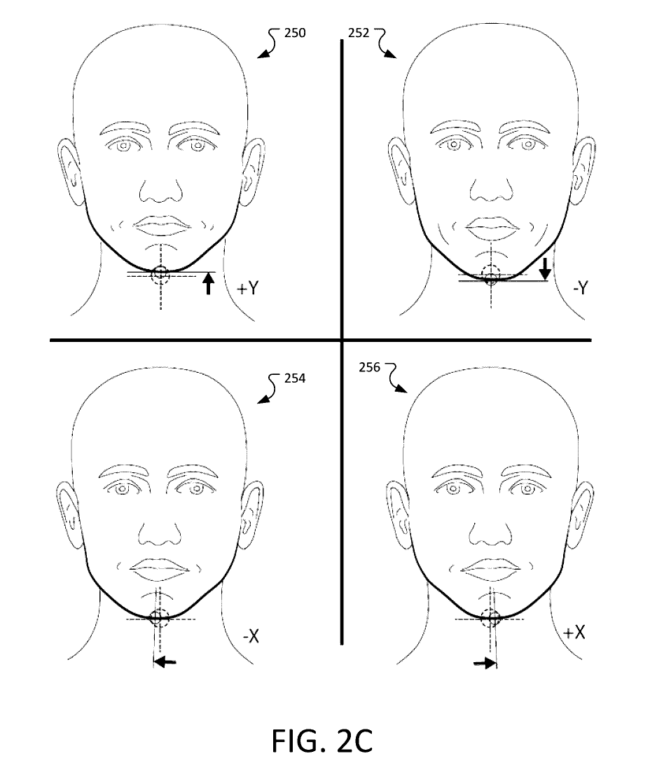

FIGS. 2A-C illustrates an example of a user 202 controlling a computing device using the position of his chin. A system can identify a position of the user's chin. For example, the circle 204 represents the identified the position of the user's chin. The system can identify a resting position for the user's chin. For example, the dotted circle 206 represents the resting position of the user's chin. In this example, the user's chin is at the resting position. In some implementations, the system may calibrate the resting position to be assigned to a value of 0 on an x axis 208 and a value of 0 on a y axis 210. The resting position may be, for example, the position of the user's chin when the user 202 is relaxed with the teeth comfortably separated but the mouth closed (for example, the lower teeth may be between 0.5 cm and 1.5 cm apart), and user defined beyond a system's default settings.

Not all user's may wish to control the computing device using the chin. For example, individuals with a beard may not have a chin that is reliably locatable by the computer system. Accordingly, the user may, alternatively, control the computing device using another facial feature such as the user's nose.

In some implementations, the resting position may be identified using a configuration process. For example, the user 202 may start a calibration process by causing a program or subroutine to execute. A message on the user interface may instruct the user 202 to sit in a resting position. A capture sensor can send information to a computing device, for example, an image or images of the user's face. The computing device can identify the position of the user's chin, for instance. In some implementations, the capture sensor may send multiple images or a video of the user's chin. The computing device may determine a position of the chin for each image or frame of the video.

The dotted circle 206 representing the resting position of the chin is larger than the circle 204 representing the identified position of the chin. In some implementations, the resting position may be larger than the position of the chin during calibration to account for the natural movement of the user 202. In some implementations, the resting position may be based on an amalgamation of the identified resting positions from multiple images. As used herein, an image may also refer to a frame in a video stream. In some implementations, recalibrating the system may be performed with a single key press, or through a simple signal.

In some implementations, the position of the chin may be determined relative to another part of the user's body. For example, the position of the chin may be determined relative to the user's nose, thus enabling the system to account for the natural motion of the user's head.

Referring to FIG. 2B, as the user 202 moves his chin, the system can detect the location of the chin has changed. For example, a capture sensor may send an image of the user 202 to a computing device. The computing device may determine the location of the chin. In this example, the chin is not in the resting position, but instead has moved to the location identified by the circle 220. The coordinates of the location, relative to the resting position, may be determined based on a new location identified by a new X value 224 and a new Y value 222.

The detected change in the user's chin may cause the computing device to perform an action. For example, the user 202 is using the user interface 226 to view a web page 250. By moving the user's chin from the resting location (represented by dashed circle 206) to a new location (represented by the circle 220), a computing device (for example, the computing device 108 of FIG. 1) may move the cursor from the position 228a to a new position 228b.

In some implementations, the position of the cursor on the screen may be determined based on the location of the user's chin relative the resting position. For example, the resting position (0, 0) may represent the geometric center of the user interface. When the user 202 moves his chin in the positive X and negative Y direction, for example, to a location (X, −Y) the cursor is placed on a corresponding location on the screen (X, −Y). Each time the user 202 moves his chin to the same position, the cursor moves to the same location.

In some implementations, the position over time (compared to sampling frequency) of the user's chin relative to the resting position may determine the velocity of the cursor. The direction that the cursor moves can be determined based on the vector, calculated by the difference between the resting position and the position of the user's chin. For example, when the user moves his chin to the (X, −Y) (that is, down and to the right) position the cursor moves in the X, −Y direction (again down and to the right). The speed at which the cursor moves may be determined based on the distance between the position of the chin and the resting position over time. For example, if the user 202 moves his chin far from the resting position per unit time, the cursor moves relatively quickly. If the user 202 moves his chin a small distance from the resting position, then the cursor moves relatively slowly.

FIG. 2C illustrates examples of directions the user 202 may move his chin. In image 250, the user 202 has pushed his teeth closer together from the resting position, causing his chin to rise in a positive Y direction. In image 252 the user 202 has spread his teeth further apart causing the chin to move down in a negative Y direction. In image 254 the user 202 has moved his chin to the right (in a negative X direction). In image 256 the user 202 has moved his chin to the left (in a positive X direction). Each of these directions can effects movement, and can be combined for movement at angles to substitute for standard mouse and touch-screen interaction, allowing for finer control in non-linear directions.

Although the system has described the motion of the chin in terms of positive and negative X and Y, other implementations may be used. For example, the signs of X and/or Y may be reversed.

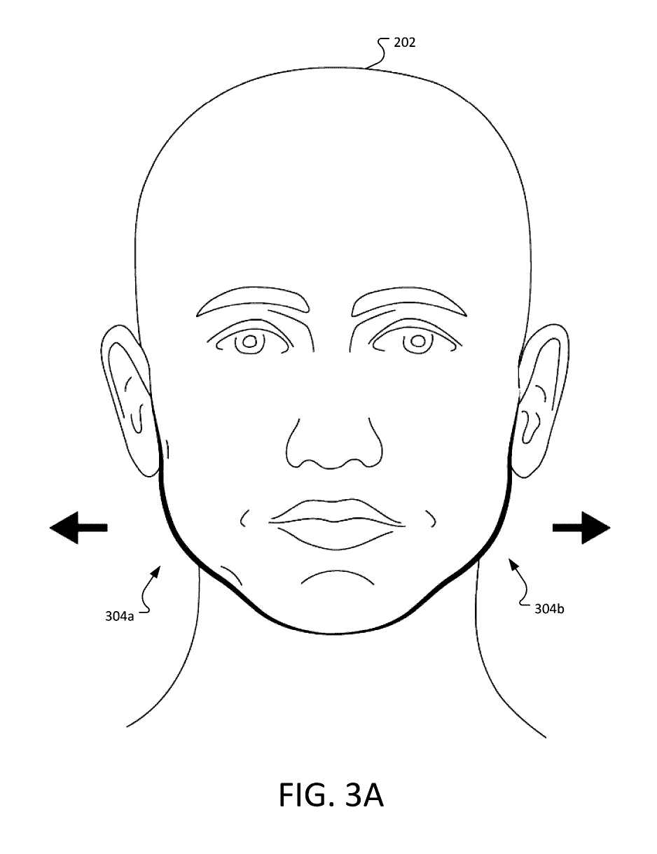

FIG. 3A-C illustrates the user 202 controlling a computing device by inflating his cheeks. The system may detect when the user 202 inflates his cheeks, for example, with air. Referring to FIG. 3A, the user 202 inflates both of his cheeks 304a, 304b. The system may detect the expansion of the cheeks of the user 202 and, as a result, take some action. In one implementations, expanding both cheeks can cause the cursor pointer to move more precisely or to stop motion for a period of time. For example, as described above, the user 202 may control the direction and speed of the cursor pointer using the position of his chin. If the cursor reaches a desired position, the user 202 may inflate both cheeks to cause the cursor pointer to stop moving.

In some implementations, the system may cause the cursor to be unresponsive to movement of the chin for a period of time after both cheeks are inflated (for example, for 1 second, 0.5 seconds, etc.). Thereby providing the user 202 with a new start position, and/or time to reset his chin into the resting position, similar to lifting a mouse or finger off surface.

Referring to FIG. 3B, inflating a right cheek 306 may be independently detected by the system. For example, the system may detect that the user 202 has inflated his right check 306 without inflating the left cheek.

In some implementations, the system may perform a right mouse click action in response to detecting that the right cheek 306 is inflated without the other. For example, the user 202 is viewing a web page 250 on the user interface 226. When the user 202 inflates his right cheek 306, a contextual menu 310 is opened on the user interface 226 at the location of a cursor pointer 312.

Referring to FIG. 3C, inflating a left cheek may be independently detected by the system. For example, the system may detect that the user 202 has inflated his left cheek 314, without inflating his right cheek. In some implementations, the system may perform a left mouse click action, or finger tap selection on a touch-screen, in response to detecting that the left cheek 314 is inflated without the other. For example, the user 202 is viewing the web page 250 on the user interface 226. When the user 202 inflates his left cheek 314, an item is selected (as represented by the box with the thick line 316) based on the position of the cursor pointer 312.

Similarly, inflating and deflating a cheek twice within a predetermined time period may be associated with a double click. For example, inflating and deflating the right cheek twice within a predetermined time period may be associated with a right double click. Inflating and deflating the left cheek twice within a predetermined time period may be associated with a left double click. In some implementations, the time period may be configurable by the user 202, within a range. For example, the user 202 may be able select a time period between 0.25 seconds and 5 seconds.

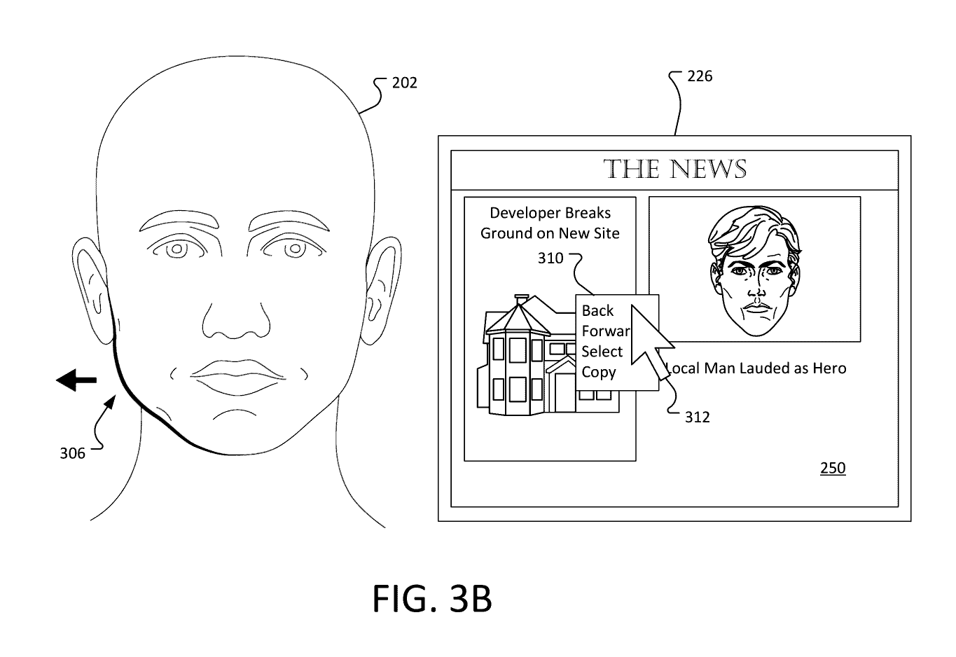

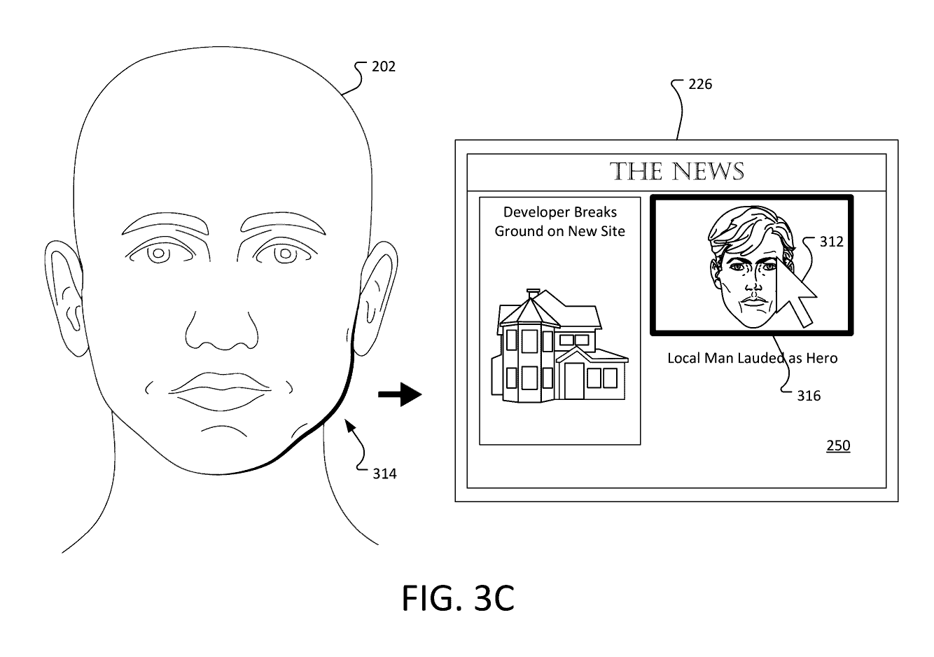

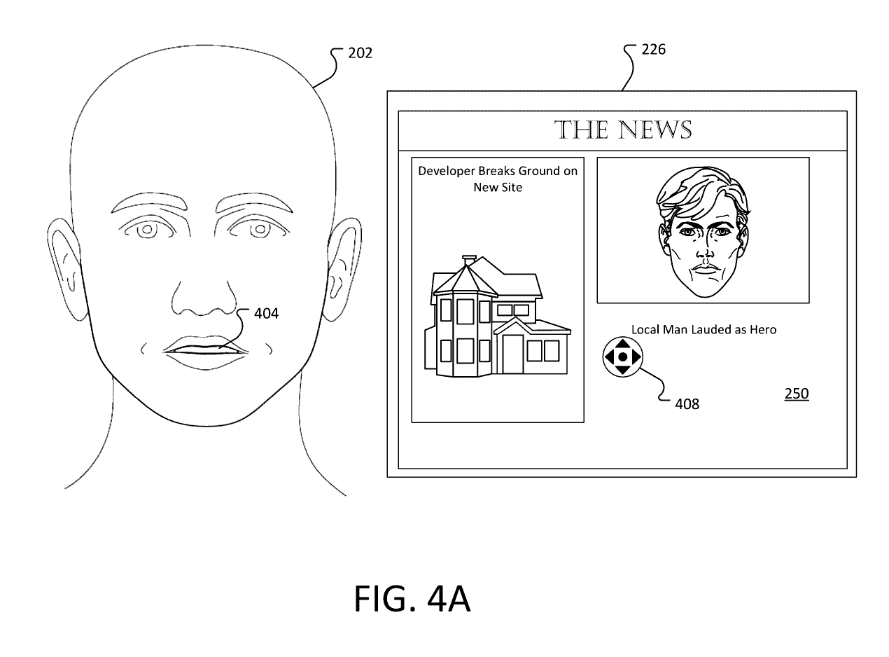

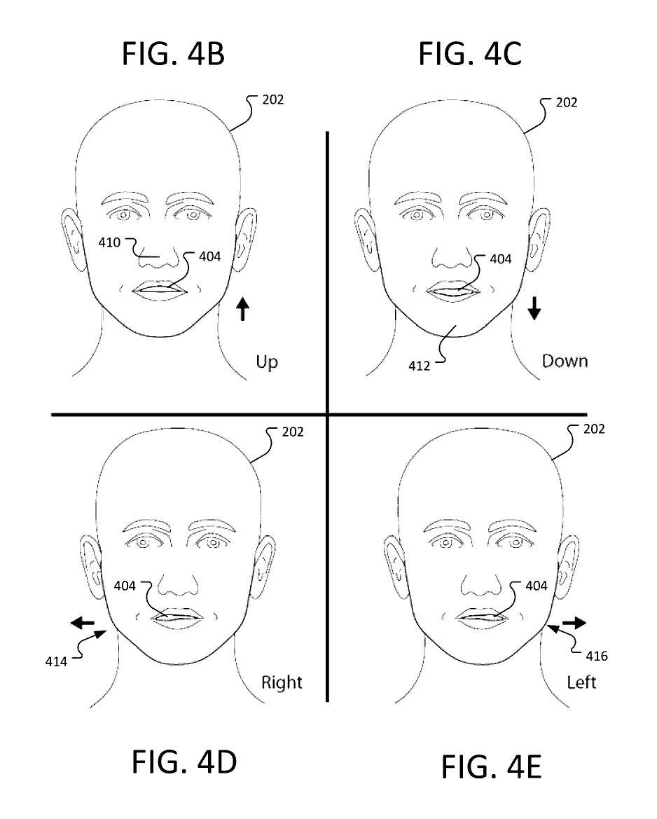

FIGS. 4A-E illustrate an example of the user 202 controlling a computing device using the tongue. Referring to FIG. 4A, the system may detect that the user 202 has advanced his tongue 404. In response to detecting the user's tongue movement 404, the system may perform an action. In this example, sticking out the tongue 404 results in the cursor pointer 408 on the user interface 226 to switch into scroll mode. Scroll mode may be indicated by a temporary change in the shape of the cursor pointer 408.

The direction of the scroll can be determined by the direction of the user's tongue 404. For example, referring to FIG. 4B if the user 202 sticks his tongue 404 upwards towards the user's nose, the system may cause the computing device to scroll up. Referring to FIG. 4C, if the user 202 sticks his tongue 404 downward toward the user's chin 412, the system may cause the computing device to scroll down. Referring to FIG. 4D, if the user 202 sticks his tongue 404 to the right towards the user's right lip corner 414, the system may cause the computing device to scroll to the right. Referring to FIG. 4E, if the user 202 sticks his tongue 404 to the left toward the user's left lip corner 416, the system may cause the computing device to scroll to the left.

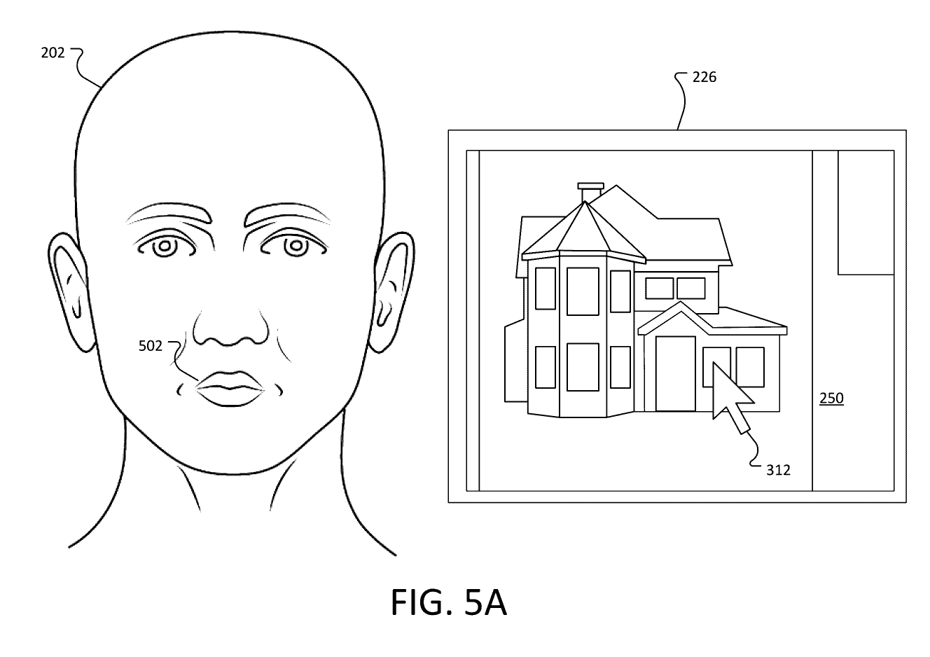

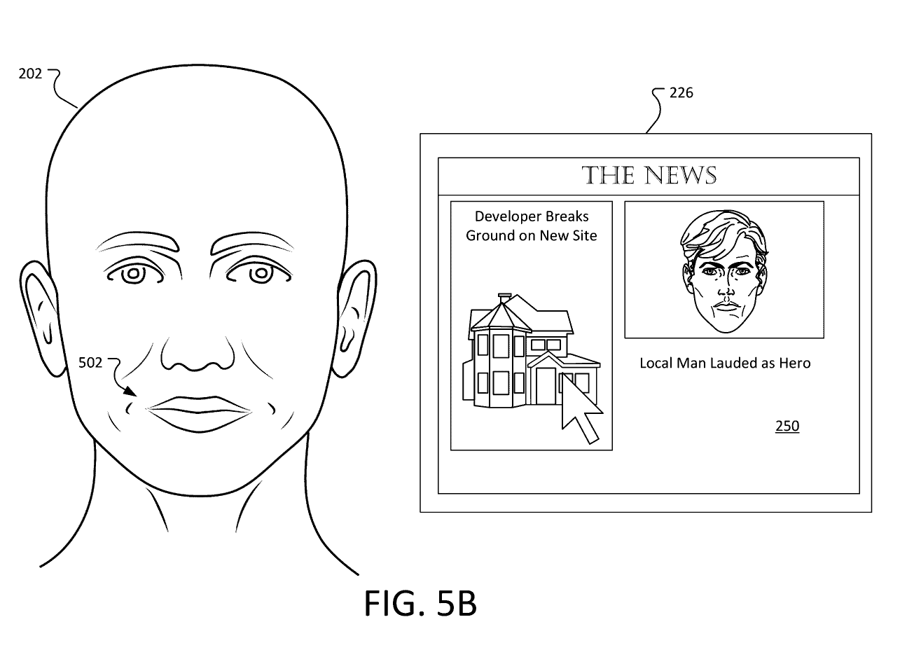

FIGS. 5A-B illustrates an example of a user 202 controlling a computing device using the shape of his mouth. Referring to FIG. 5A, the user may purse his lips. When the system detects that the user 202 has pursed his lips 502, the system may cause the computing device to perform an action. In this example, the computing device causes the user interface 226 to zoom in to provide a close up view of the object located at the cursor pointer 312. In t

Referring to FIG. 5B, the user may expand his lips 502, for example, by retracting the lips. When the lips 502 are expanded the corners of the lips 502 stretch in the direction of the cheeks. When the system detects that the user 202 has retracted his lips, the system may cause the computing device to perform an action. In this example, the computing device causes the user interface 226 to zoom out.

While exemplary actions have been described in association with different facial movements, in some implementations, the system can enable a user to customize the actions. The user may customize the actions associated with the different facial expressions/movements. For example, the user may select which action corresponds to a click, double click, zoom in, zoom out, directional scrolling, etc. The system may store the user's preferences and associate them with a particular user. For example, the computing system may use facial recognition techniques to identify the user and load that user's preferences. Further, additional facial movements may be detected such as rubbing lips together and/or pressed lips together in a smoothing motion., for example, as is applying lipstick (referred to herein as a lipstick pose), dramatic pursing of the lips as if to kiss (referred to herein as a kiss pose), smiling, and/or raising of one or more eyebrows.

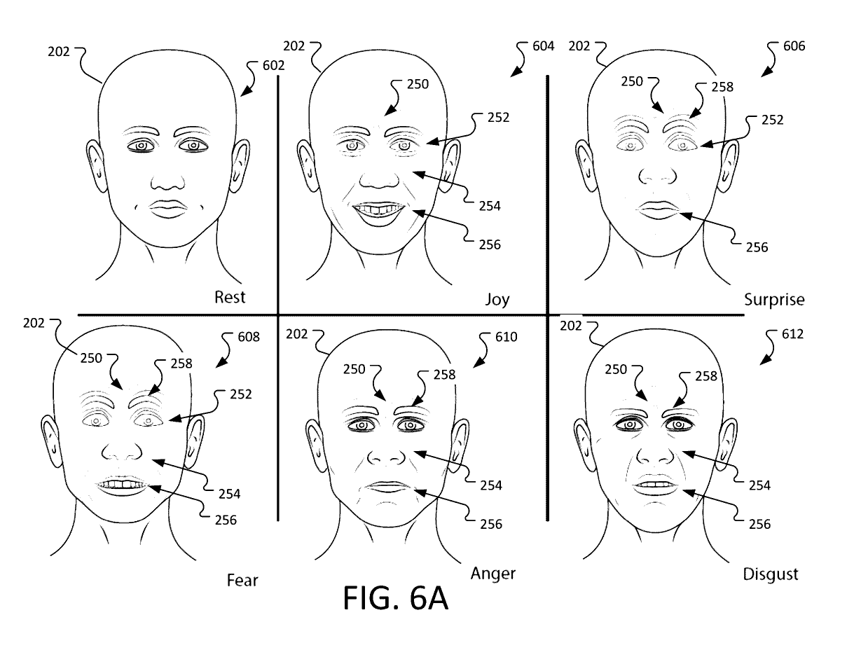

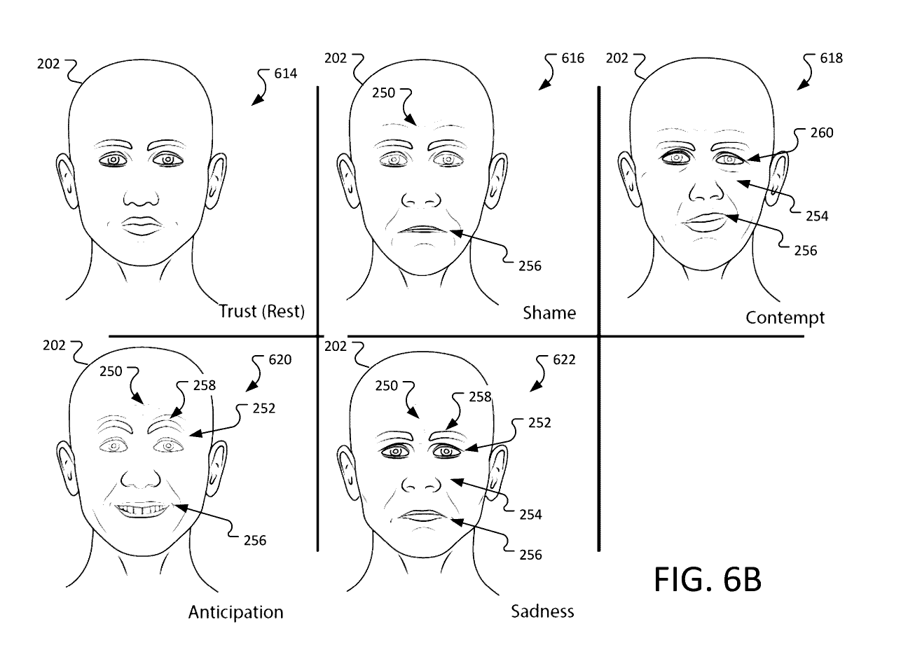

FIG. 6A-B illustrates examples of facial expressions that can be detected on the face of the user 202. Facial expressions are made by the aggregate motion and/or positions of the muscles beneath the skin of the face of a user 202. Facial expressions convey non-verbal cues, which reflect the mental state of the user 202. Human facial expressions are relatively consistent across societal lines, for example, people in China convey the same non-verbal cues as people in Australia, the European Union, and the United States, and in substantially the same way. The system may determine the facial expression of the user from an image through a comparative analysis of core human emotion expression via changes to the positions and orientations of the known units or segments of a person's face. Both partial and full-face interpretations can be made, to allow for the complexity of communications during any given point of emotive facial expression.

For example, referring to FIG. 6A, the computing device may be able to detect if the user 202 is calm 602, if the user 202 is joyful 604, if the user is surprised 606, if the user 202 is fearful 608, if the user 202 is angry 610, if the user 202 is disgusted 612. Referring to FIG. 6B, the computing device may be able to detect if the user 202 feels trust 614, if the user 202 feels shame 616, if the user 202 feels contempt 618, if the user 202 feels anticipation 620, and if the user 202 feels sadness 622. Other facial expressions may also be detected, including but not limited to sorrow.

Detecting the emotions and feelings of the user can be performed by identifying changes to areas of the user's face. For example, the computing device may determine that the user 202 is feeling joyful 604 based on evidence of a slight brow line change 250, the orbicularis oculi muscles 252 are slightly drawn up around the eye, the cheek muscles 254 are tightened, and/or the corners of the lips 256 have a straight upward position, the mouth is open wide, and/or the jaw is drawn downward.

The computing device may determine that the user 202 is feeling surprised 606 based on evidence of a slight brow line change 250, raised eye brows 258, the orbicularis oculi muscles 252 are stretched wide open, the mouth is closed or partly open with full lips 256, and/or the jaw is drawn downward.

The computing device may determine that the user 202 is feeling fear 608 based on evidence of a high brow line 250, raised eyebrows 258, the orbicularis oculi muscles 252 are stretched open, the cheek muscles 254 are tightened outward, and the mouth is open with narrow lips 256 drawn wide at the corners.

The computing device may determine that the user 202 is feeling anger 610 based on evidence the brow line 250 and eye brows 258 being very tight and corrugator muscles contracted inward, the cheek muscles 254 tightened inward, narrow lips 256 tightened at the corners, the corners of the lips 256 drooping down, and/or the jaw being tightly closed.

The computing device may determine that the user 202 is feeling disgust 612 based on evidence of the brow line 250 and eye brows 258 of the glabella area being very tight and contracted inward, the cheek muscles 254 being tightened, and full lips 256 with the mouth open, the upper lip being raised, and/or the jaw is drawn downward.

The computing device may determine that the user 202 is feeling shame 616 based on evidence of a low brow line 250, narrow lips 256, with a slight drooping of the lip corners, and/or bulging muscles surrounding the mouth.

The computing device may determine that the user 202 is feeling contempt 618 based on evidence of a drooping eye 260 on one side of the face, cheek muscles 254 being pulled upward on one side, and/or the lip 256 corners tightened and raised on one side of the face.

The computing device may determine that the user 202 is feeling anticipation 620 based on evidence of a high brow line 250, raised eye brows 258. The orbicularis oculi muscles 252 being stretched open, narrowed lips 256, and/or biting of lower lip.

The computing device may determine that the user 202 is feeling sadness 622 based on evidence of the brow line 250 and eye brows 258 of the glabella area being very tight and contracted inward. The upper orbicularis oculi 252 muscles drooping down, narrowing of the lips 256, and/or a slight drooping down of the lip corners.

Because facial expressions may be more or less involuntary reactions to external stimuli, analyzing facial expressions may provide input into managing a user's experience with the system, and also communicate that user's feelings, with or without intent, to whomever that user is connected. For example, if the user's facial expression indicates anger or disgust regularly after attempting to perform one or more of the activities described above, the system may determine that the control scheme should be recalibrated.

The facial expression can also be used to customize a user's experience. For example, the user's facial expression may be collected used as a critique of particular content. In some implementations, the content experienced by the user may be altered based on the facial expressions. For example, a video game may include degrees of tension and difficulty. If the user provides the appropriate expected reactions (as conveyed through facial expression), then the selected degree may be maintained. If users are not responding with the expected reactions, then the selected degree may be altered. For example, a horror based game may increase the number of jump scares. In some scenarios, the difficulty of a game may be automatically increased or decreased based on the user's facial expression. In a role playing game, non-player characters may react to the user's facial expression.

Facial expressions can also be used to expand the user experience with on-line interactions. Currently a large number of individuals play video games together on-line. The individuals can play cooperatively or competitively. By identifying and analyzing the user's facial expression, the system can convey that expression though the video game to other players. The user's expression may be reflected on the user's avatar (in computing, an avatar can be a graphical representation of the user 202 or the user's alter ego or character). Therefore, when a user is surprised (for example, by a sneak attack in a competitive game), the user's expression may be reflected on their avatar. The player performing the sneak attack will receive a non-verbal signal that the attack worked, thereby enhancing their gaming experience. Similarly, when the user 202 completes a particular difficult or rewarding task, their joy can be graphically transmitted to their opponents and compatriots.

Further facial expressions may be used as a form of non-verbal communication between participants in an interactive forum, such as on social media platforms. A frown (e.g. transmitted via the user's avatar or on a numerical scale) may signify disapproval or disagreement, a smile (e.g. transmitted via the avatar or on a numerical scale) may indicate assent, etc . . . For example, the user's reaction may be interpreted by his facial expression, and can be assigned grades of emotionality along a numerical or graphical spectrum, when engaged by a discussion. Another example is the facial expression of the user can be directly assigned to be replicated on the face of an avatar in a social media virtual reality world, for greater depth and complexity of communication. This can enhance the quality and dimensions of the user interactive social experience.

Further facial expressions may be used as a form of non-verbal communication between participants in a commercial setting, such as on vendor websites, or to advertisements placed on any platform, from social media to websites to mobile platforms. A frown (e.g. transmitted via the avatar or re-interpreted on a numerical scale) may signify disapproval or disagreement, a smile (e.g. transmitted via the avatar or on a numerical scale) may indicate assent or receptivity to a notice or announcement, etc . . . For example, the user's reaction may be interpreted by his facial expression, and can be assigned grades of emotionality along a numerical or graphical spectrum, when engaged by a vendor announcement. Another example is the facial expression of the user can be directly assigned to be replicated on the face an avatar in a commercially-relevant virtual reality world, for greater depth of communication. This can enhance the quality and dimensions of the user interactive social and commercial experiences.

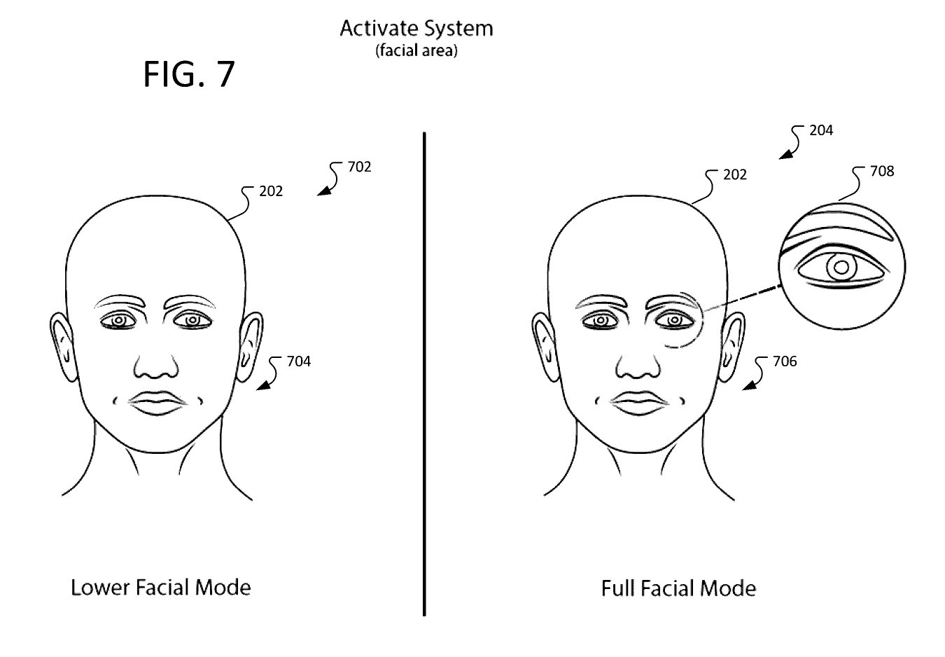

FIG. 7 illustrates an example of different areas of the user's face that can be monitored. A capture sensor, for example the capture sensor 114 of FIG. 1, can monitor a user's face. In some implementations, a system may be a lower facial system, or may operate in a lower facial mode 702. In the lower facial mode, the system may monitor the lower portion of the user face, as indicated by the shaded area 704. In some implementations, the system by a full facial system or may operate in a full facial mode 706. In the full-facial mode the system may monitor the full face of the user, as indicated by the shaded area 706, including the forehead and areas around the eyes. In some implementations, the full facial mode may also monitor the motion of the user's eyes 708. Motion of the eyes (such as blinking in succession, closing the eyes, raising eyebrows, etc.) can also be translated into input commands, either as part of the system settings, or as defined by the user.

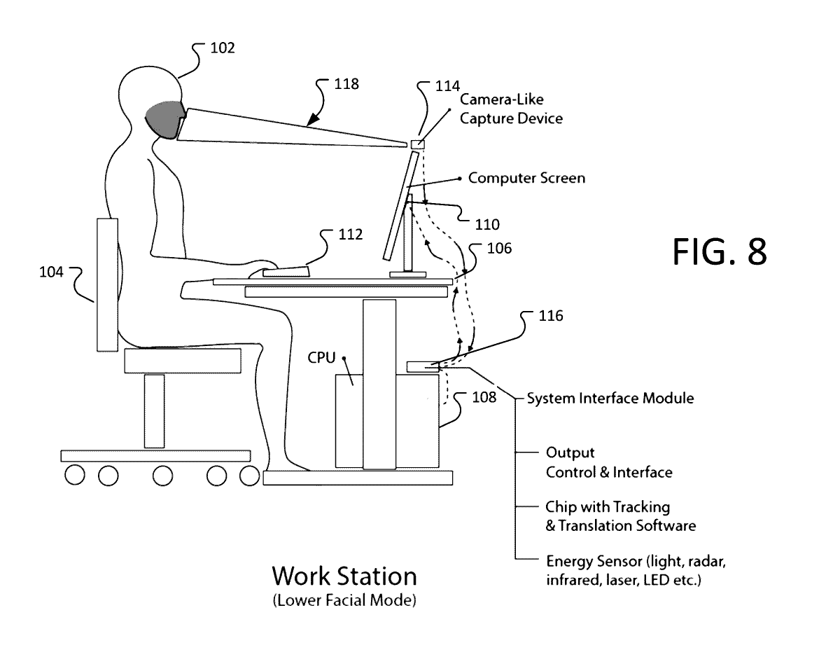

FIG. 8 illustrates a larger view of an example of a workstation operating in lower facial mode. As described above, a user 102 can operate a computing device 108 using a keyboard 122 and a capture sensor 114. The computing device 108 can be a desktop computer.

In some implementations, input from the capture sensor can be connected to a system interface module 116. The system interface module 116 may include special purpose hardware, such as computer microchips and circuitry, which are specifically configured to detect actions in the user's face, for example, the actions described above. The special purpose hardware may include tracking and translation software encoded into the chip or stored in a non-transitory readable memory that enables the system interface module 116 to identify facial movement and translate the facial movement into commands for the computing device 108. The system interface module 116 may connect to the computing device 108 through an interface, for example, a Universal Serial Bus interface (USB). The system interface module 116 may connect to the capture sensor 114 using an interface. In some implementations, the system interface module includes a host USB port for accepting a connection to the camera-like device 116 and may have a device USB port for connecting to the computing device. The system interface module 116 may draw power from the computing device or may be separately powered (for example, using a connection to an electrical outlet). In some implementations, the system interface module 116 may include or connect to different sensors. For example, the system interface module may connect to light, light-emitting diode, radar, infrared, or laser based sensors.

In other implementations, the capture sensor 114 may connect directly into the computing device 108. The computing device may include special purpose hardware (for example, a PCI board) or software (such as a driver or computer program being executed by the computing device) that is configured to identify the facial movement and translate the facial movement into commands.

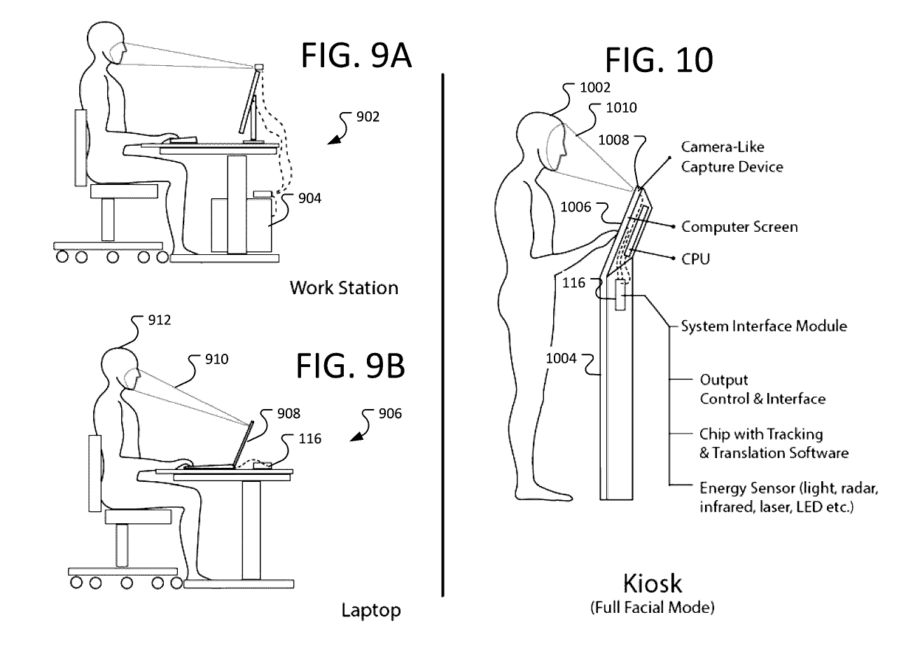

FIGS. 9A-B illustrate example computing devices which can provide a facial movement translation. Referring to FIG. 9A, the capture system 902 includes a workstation 904. The workstation may be, for example, the computing device 108 of FIG. 1 and FIG. 8.

Referring to FIG. 9B, the capture system 906 includes a laptop computer 908. Represented by the cone 910, the capture system 906 may monitor the face of a user 912 user a camera integrated to the laptop 908, or, alternatively, an external capture sensor (not shown). In this example, the system is shown operating in lower facial mode; however, the system can also operate in full facial mode. The images provided from the camera or capture sensor may be processed using the system interface device 116 connected to the laptop. Alternatively, the images provided by the camera or capture sensor may be processed by dedicated hardware or software within the laptop 908.

FIG. 10 illustrates an example kiosk that monitors a user's face. A user 1002 may operate a kiosk 1004. The kiosk 1004 may include a touch screen monitor 1006 or a monitor and keypad/keyboard. The kiosk 1004 includes a capture sensor 1008 integrated into the kiosk 1004. the capture sensor 1008 monitors the user's face, as illustrated by the cone 1010. In this example, the capture sensor 1008 is illustrated as operating in full facial mode, although in some implementations the capture sensor 1008 may operate in lower facial mode. The kiosk 1004 may include a systems interface module 116 integrated into the kiosk 1004. Alternatively, the kiosk may include a processing unit that accepts images from the capture sensor 1008 and uses the images to perform actions, as described above.

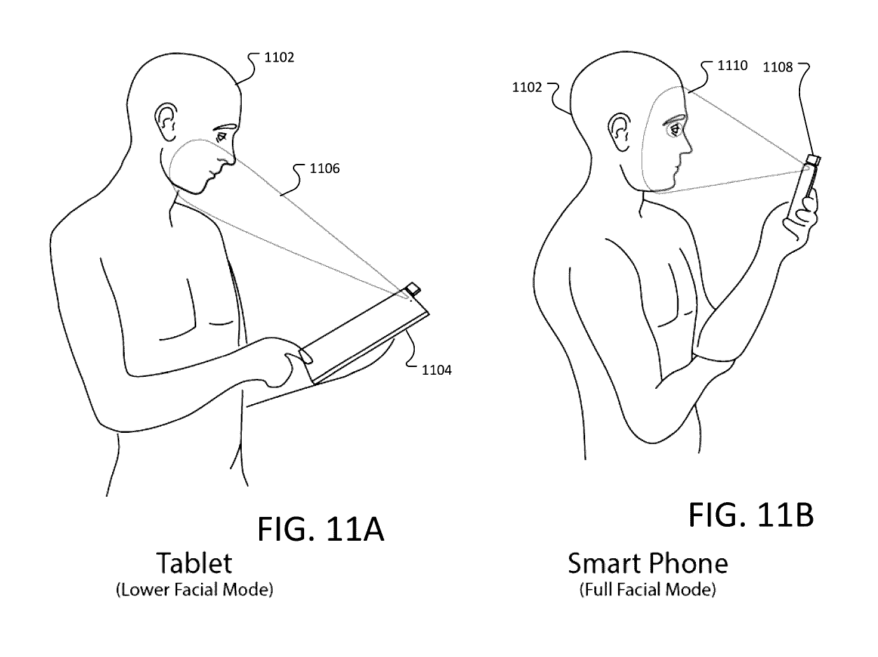

FIGS. 11A-B illustrate handheld devices that utilize facial monitoring. Referring to FIG. 11A, a user 1102 holds a tablet computer 1104. The tablet computer includes a camera that can function as a capture sensor. An external device may be attached to the tablet to function as a capture sensor. The camera monitors the user's face, as illustrated by the cone 1106. Software executing on the tablet 1104 can identify facial expressions and actions as described above. The software can translate the facial expressions and actions into input commands which are processed by the tablet 1104. In this example, the tablet 1104 is shown operating in lower facial mode. In other implementations, the tablet 1104 may function in full facial mode.

Referring to FIG. 11B, the user 1102 holds a smart phone 1108. The smart phone includes a camera that can function as a capture sensor. An external device may be attached to the tablet to function as a capture sensor. The camera monitors the user's face, as illustrated by the cone 1110. Software executing on the smart phone 1108 can identify facial expressions and actions as described above. The software can translate the facial expressions and actions into input commands which are processed by the smart phone 1108. In this example, the smart phone 1108 is shown operating in full facial mode. In other implementations, the smart phone 1108 may function in lower facial mode.

Other handheld devices may also be used. For example, a personal digital assistant or an e-book.

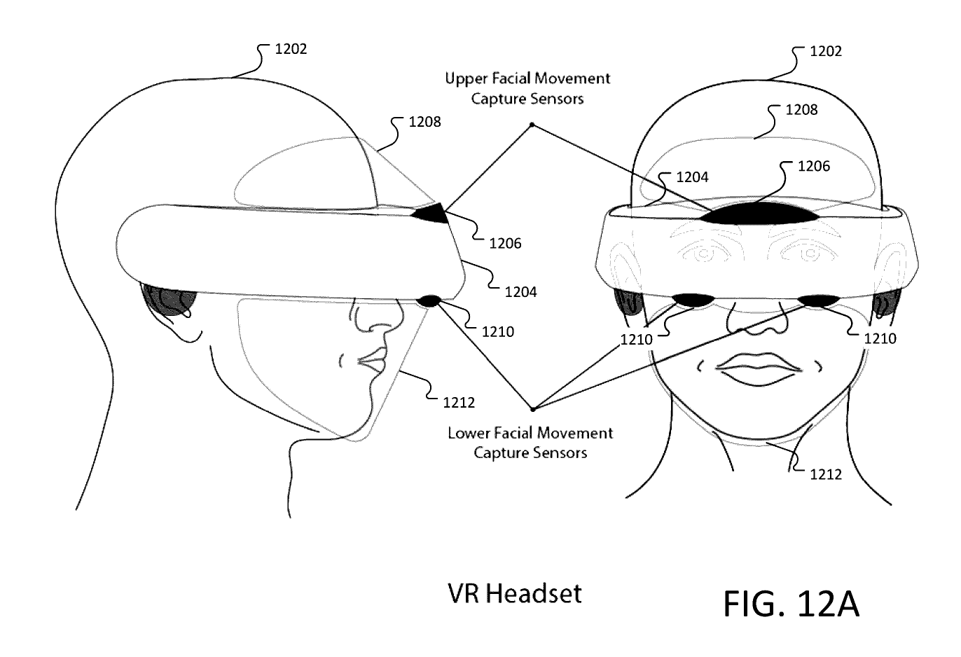

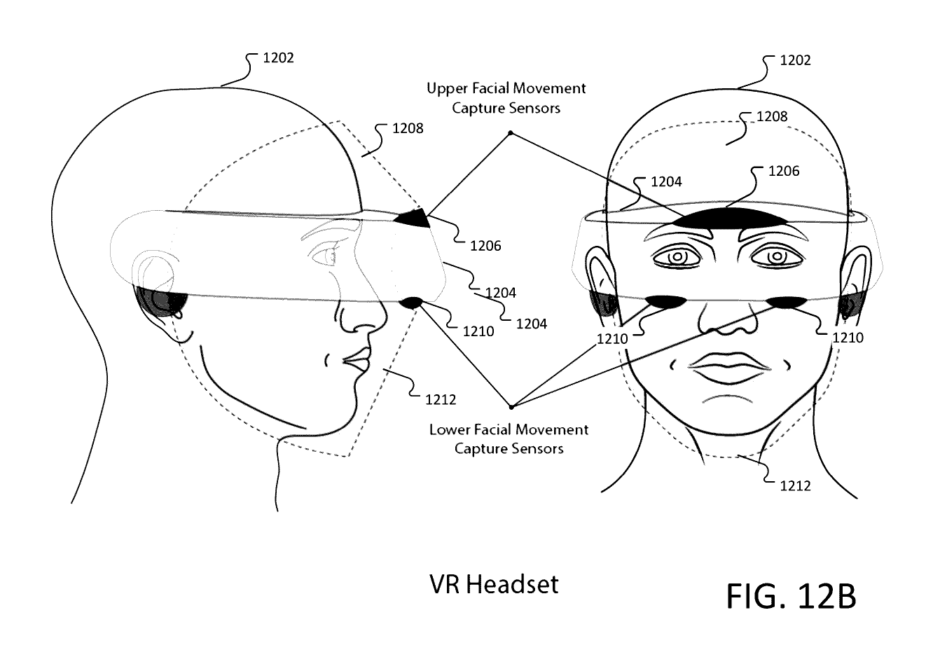

FIG. 12A-B illustrates an example of virtual reality headsets that include facial monitoring. Referring to FIG. 12A, a user 1202 wears a virtual reality headset 1204. The virtual reality headset 1204 includes an upper facial movement capture sensor 1206 that can monitor the forehead and upper face of the user 1202, as illustrated by the shaded area 1208. The virtual reality headset 1204 also includes two lower facial movement capture sensors 1210 that can capture movement of the lower portion of the user's face, as illustrated by the shaded area 1212. The virtual reality headset may be connected to a computational device, for example, a personal computer, game console, or other device (not shown). Information from the upper facial movement sensor and lower facial movement sensors can be processed by a computational device to translate the facial movement into input commands.

In this example, the area of the user's face covered by the virtual reality headset 1204 may not to monitored for facial movement.

Referring to FIG. 12B, in some implementations, the virtual reality headset 1204 may include sensors capable of monitoring the full face of the user. For example, the virtual reality headset 1204 may include a capture sensor inside the headset (not shown) that enables the system to monitor the user's entire face.

Other examples of useful platforms may involve an entertainment chamber-suite in a hotel or entertainment venue system, whole-room theaters in a home system, a ground vehicle, an airplane or spaceship cockpit, onboard a floating or submersed vessel, political or scientific survey booths etc. with sensors pre-mounted in a tailored manner and configured to allow the present user-computer interface, for control and virtual reality functionality from facial expressions, as described above in each of these site-specific settings.

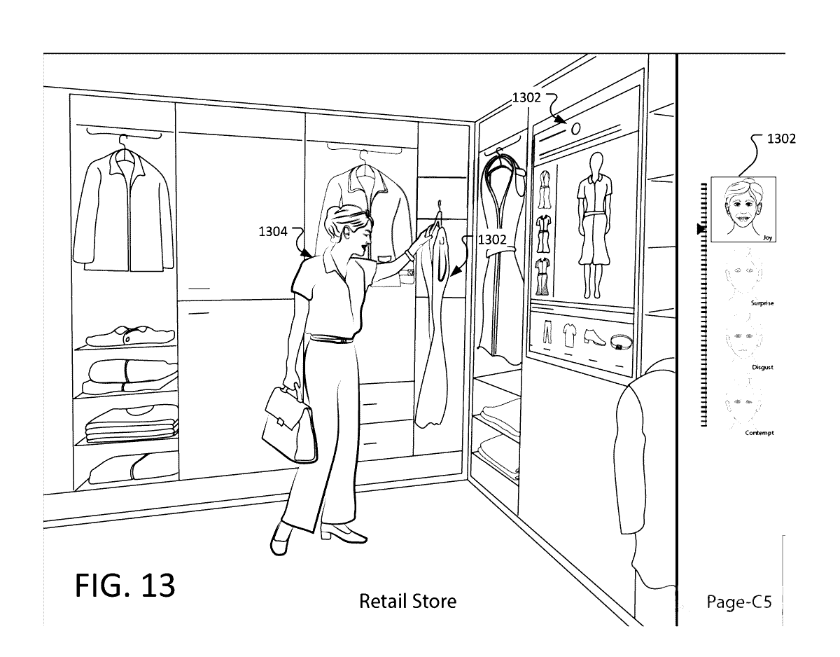

FIG. 13 illustrates an example of using a camera with emotion detection capabilities in a retail establishment. A camera 1302 can monitor the facial expressions of a potential customer 1304 as she looks at merchandise 1302.

In some implementations, the camera 1302 may be coupled to a computing device (not shown) that evaluates the user's facial expression. For example, the potential customer's facial expression may be evaluated on a range of joy to surprise to disgust to contempt. In some implementations, the information about the potential customer's experience may be conveyed via computer algorithm, or to a store clerk (not shown) in order to enable the store or clerk to better serve the potential customer 1304.

In some implementations, the information about the potential customer's facial expression while looking at the merchandise 1302 may be recorded and analyzed (along with information from other potential customers. The information may be used as an informal survey as to the desirability of the merchandise 1302. In some implementations, the desirability of the merchandise 1302 can be measured with respect to different demographics, including an estimation of gender, age, social class, etc.

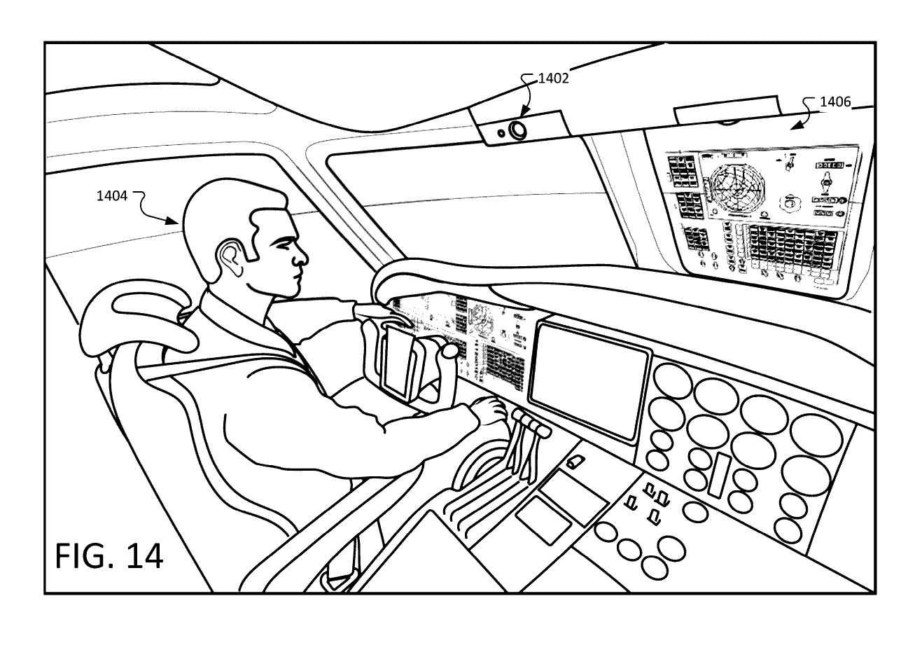

FIG. 14 illustrates of an example of using a camera in a cockpit. The camera 1402 can monitor the facial expressions and facial motion of a pilot 1404. The pilot 1404 can use his facial movements to control, for example, a computer system 1406 (for example, a navigation system, an autopilot system, a weather report, radio, etc.).

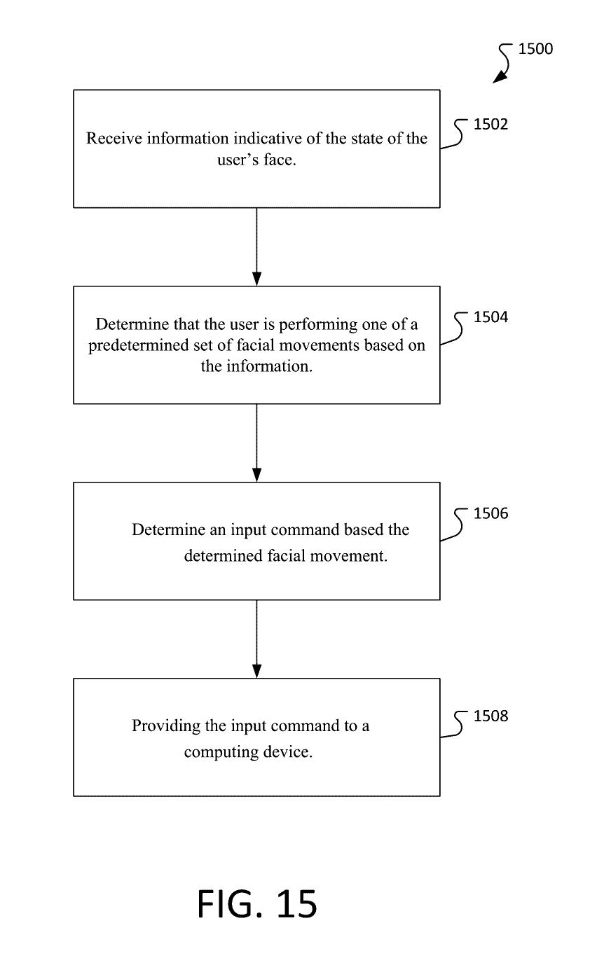

FIG. 15 is a flowchart of an example of a process for a human computer interface.

The process 1500 receives 1502 information indicative of the state of the user's face. The information can be received from a capture device, such as a camera.

The process 1500 determines 1504 that the user is performing one of a predetermined set of facial movements based on the information.

The process 1500 determines 1506 an input command based the determined facial movement.

The process 1500 provides 1508 the input command to a computing device.

Embodiments of the subject matter and the operations described in this specification can be implemented in digital electronic circuitry, or in computer software, firmware, or hardware, including the structures disclosed in this specification and his structural equivalents, or in combinations of one or more of them. Embodiments of the subject matter described in this specification can be implemented as one or more computer programs (i.e., one or more modules of computer program instructions, encoded on computer storage mediums for execution by, or to control the operation of, data processing apparatus). A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices). The computer storage medium can be non-transitory.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example, a programmable processor, a computer, a system on a chip, or multiple ones, or combinations, of the foregoing. The apparatus can include special purpose logic circuitry (e.g., an FPGA (field programmable gate array) or an ASIC (application-specific integrated circuit)). The apparatus can also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry (e.g., an FPGA (field programmable gate array) or an ASIC (application-specific integrated circuit)).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive, data from or transfer data to, or both, one or more mass storage devices for storing data (e.g., magnetic, magneto-optical disks, or optical disks), however, a computer need not have such devices. Moreover, a computer can be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive)), to name just a few. Devices suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks. The processor and the memory can be supplemented by, or incorporated in, special purpose logic circuitry.

To provide for interaction with the user 202, embodiments of the subject matter described in this specification can be implemented on a computer having a display device (e.g., a CRT (cathode ray tube) or LCD (liquid crystal display) monitor) for displaying information to the user 202 and a keyboard and a pointing device (e.g., a mouse or a trackball) by which the user 202 can provide input to the computer. Other kinds of devices can be used to provide for interaction with the user 202 as well; for example, feedback provided to the user 202 can be any form of sensory feedback (e.g., visual feedback, auditory feedback, or tactile feedback) and input from the user 202 can be received in any form, including acoustic, speech, or tactile input. In addition, a computer can interact with the user 202 by sending documents to and receiving documents from a device that is used by the user 202 (for example, by sending web pages to a web browser on the user's user 202 device in response to requests received from the web browser).

Embodiments of the subject matter described in this specification can be implemented in a computing system that includes a back-end component (e.g., as a data server), a middleware component (e.g., an application server), or a front-end component (e.g., the user 202 computer having a graphical user 202 interface or a Web browser through which the user 202 can interact with an implementation of the subject matter described in this specification), or any combination of one or more such back-end, middleware, or front-end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include user 202s and servers. The user 202 and server are generally remote from each other and typically interact through a communication network. The relationship of user 202 and server arises by virtue of computer programs running on the respective computers and having the user 202-server relationship to each other. In some embodiments, a server transmits data (e.g., an HTML page) to the user 202 device (e.g., for purposes of displaying data to and receiving user 202 input from the user 202 interacting with the user 202 device). Data generated at the user 202 device (e.g., a result of the user 202 interaction) can be received from the user 202 device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can, in some cases, be excised from the combination, and the claimed combination may be directed to a sub combination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
a capture sensor; and
a computing device coupled to the capture sensor, the computer comprising one or more processors a computer-readable medium coupled to the at least one computer having instructions stored thereon which, when executed by the one or more processors, cause the computing device to perform operations comprising:
receiving, from a capture sensor, information indicative of the state of the face of the user;
determining that the user is performing one of a predetermined set of facial movements based on the information;
determining an input command based the determined facial movement; and
executing the input command on the computing device.

2. The system of claim 1, wherein the operations further comprise locating a cursor on a user interface of the computing device based on a position of a chin or a nose of the user.

3. The system of claim 2, wherein the position of the chin or the nose is determined relative to another facial feature of the user.

4. The system of claim 2, wherein the operations further comprise causing a cursor to move based on the movement of the chin or nose of the user.

5. The system of claim 1, wherein the facial movement include at least one of inflating a cheek of the user, sticking out of a tongue of the user, pursing lips of the user, rubbing the lips together, a lipstick pose, a kiss pose, smiling, raising eyebrows, and expanding corners of the lips.

6. The system of claim 1, wherein inflating the cheek of the user causes the computing device to execute to a mouse click input command.

7. The system of claim 6, wherein determining the input command comprises selecting between a click input command and a double click input command based on a timing and a repetition of the inflating of the cheek.

8. The system of claim 6, wherein determining the input command comprises selecting between a left click input command and a right click input command based on which check the user inflates.

9. The system of claim 1, wherein sticking out of a tongue of the user causes the computing device to execute to a scroll input command.

10. The system of claim 9, wherein the direction of the scroll command is based on the direction of the tongue.

11. The system of claim 1, wherein pursing the lips causes the computing device to execute to a zoom in command.

12. The system of claim 1, wherein stretching the lips causes the computing device to execute to a zoom out command.

13. The system of claim 1, wherein the operations further comprise detecting a facial expression indicative of at least one or calm, joy, surprise, fear, anger, disgust, trust, shame, contempt, anticipation, and sadness.

14. The system of claim 13, wherein the operations further comprise adjusting the difficulty of a game based on the facial expression.

15. The system of claim 1, wherein the computing device is one of a smart phone or tablet.

16. The system of claim 1, wherein the computing device comprises a virtual reality headset.

17. The system of claim 1, wherein the computing device enables the user to configure which input commands correspond to which facial movements.

18. The system of claim 1, wherein the capture sensor is a camera.

19. The system of claim 1, wherein the capture sensor is capable of detecting heat, air pressure, infrared light, sound, electromagnetic waves, or light emission.

20. A computer-implemented method comprising:
receiving, from a capture sensor, information indicative of a state of the face of the user;
determining that the user is performing one of a predetermined set of facial movements based on the information;
determining an input command based the determined facial movement; and
executing the input command on the computing device.

21. The computer-implemented method of claim 1, wherein the operations further comprise locating a cursor on a user interface of the computing device based on a position of a chin or a nose of the user.

22. The computer-implemented method of claim 1, wherein the facial movement include at least one of inflating a cheek of the user, sticking out of a tongue of the user, pursing lips of the user, rubbing the lips together, a lipstick pose, a kiss pose, smiling, raising eyebrows, and expanding corners of the lips.

23. The computer-implemented method of claim 1, wherein the operations further comprise detecting a facial expression indicative of at least one or calm, joy, surprise, fear, anger, disgust, trust, shame, contempt, anticipation, and sadness.

24. The computer-implemented method of claim 1, wherein the computing device enables the user to configure which input commands correspond to which facial movements.

25. A non-transitory computer storage medium having instructions stored thereon which, when executed by the one or more processors, cause a computing device computer to perform operations comprising:
receiving, from a capture sensor, information indicative of a state of the face of the user;
determining that the user is performing one of a predetermined set of facial movements based on the information;
determining an input command based the determined facial movement; and
executing the input command on the computing device.

26. The non-transitory computer storage medium of claim 1, wherein the operations further comprise locating a cursor on a user interface of the computing device based on a position of a chin or a nose of the user.

27. The non-transitory computer storage medium of claim 1, wherein the facial movement include at least one of inflating a cheek of the user, sticking out of a tongue of the user, pursing lips of the user, rubbing the lips together, a lipstick pose, a kiss pose, smiling, raising eyebrows, and expanding corners of the lips.

28. The non-transitory computer storage medium of claim 1, wherein the operations further comprise detecting a facial expression indicative of at least one or calm, joy, surprise, fear, anger, disgust, trust, shame, contempt, anticipation, and sadness.

29. The non-transitory computer storage medium of claim 1, wherein the computing device enables the user to configure which input commands correspond to which facial movements.
